(19) United States
(12) Patent Application Publication
(10) Pub. No.: US 2024/0021858 A1
(43) Pub. Date: Jan. 18, 2024

(54) METHOD AND APPARATUS FOR PRODUCING A MEMBRANE ASSEMBLY IN A WEB-PROCESSING PROCESS

(71) Applicant: OPTIMA life science GmbH, Schwäbisch Hall (DE)

(72) Inventors: Johannes Jansen, Michelfeld (DE); Martin Dennert, Brey (DE)

(73) Assignee: OPTIMA life science GmbH, Schwäbisch Hall (DE)

(21) Appl. No.: 18/220,561

(22) Filed: Jul. 11, 2023

(30) Foreign Application Priority Data
Jul. 14, 2022 (DE) 102022207217.0

(51) Int. Cl. H01M 8/1004; H01M 8/1086

(52) U.S. Cl. CPC H01M 8/1004; H01M 8/1093; H01M 2008/1095

(57) ABSTRACT

The invention relates to a method and an apparatus for producing a membrane assembly in a web-processing process, comprising providing a first frame material (11) and a second frame material (12) as material from a roll, and forming the membrane assembly in a web-processing process, wherein membrane blanks (13) are laminated with the first frame material (11) and the second frame material is laminated with the composite comprising the first frame material (11) and the membrane blanks (13), and wherein the membrane assembly is formed on a rotating central roller (2).

### CROSS-REFERENCE TO RELATED APPLICATIONS

The present application claims priority to German Patent Application No. 102022207217.0, filed on Jul. 14, 2022, the entirety of which is incorporated herein by reference.

### FIELD OF APPLICATION AND PRIOR ART

The invention relates to a method and an apparatus for producing a membrane assembly in a web-processing process.

In an embodiment, the membrane assembly is a membrane electrode assembly (MEA for short) or parts thereof for a fuel cell or an electrolyser. In an embodiment, an MEA comprises a catalyst-coated membrane (CCM for short), on one side or both sides of which edge reinforcements or frames (also referred to as rims) of inexpensive and relatively resistant material are provided. For a further structure, two gas diffusion layers (GDL for short) may be applied to outer sides of the MEA. In this respect, the GDL may be applied in a process with the production of the MEA comprising the CCM and the edge reinforcements or in a spatially and/or temporally separate process. In another embodiment, an MEA comprising a membrane and two gas diffusion layers disposed thereon is provided, wherein edge reinforcements or frames are applied to one or both sides of this MEA.

Membrane assemblies for other applications, for example for electrolysers, redox flow batteries or membrane-based air humidifiers, are also known.

DE 10 2020 206 609 A1 discloses a method and an apparatus for producing membrane assemblies in a web-processing process, wherein a material composite comprising a frame material and a protective film is provided and the protective film is delaminated from the frame material before the frame material is deposited on a vacuum conveyor. Blanks of an electrode membrane film are deposited on the frame material.

### Problem and Solution

An object is to provide a method and an apparatus for producing membrane assemblies in a web-processing process, which offer more accurate positioning for the transport of a material from a roll than is possible by way of methods and apparatuses known to date.

This object is achieved by the subject matter having the features of claims 1 and 5. Advantageous embodiments emerge from the dependent claims.

According to a first aspect, a method for producing a membrane assembly in a web-processing process, in particular a membrane electrode assembly (MEA), is provided, the method comprising providing a first frame material and a second frame material as material from a roll, and forming the membrane assembly in a web-processing process, wherein membrane blanks are laminated with the first frame material and the second frame material is laminated with the composite comprising the first frame material and the membrane blanks, wherein the membrane assembly is formed on a rotating central roller, wherein the first frame material is transferred to the central roller at a first station, the membrane blanks are transferred to the central roller at a second station, downstream of the first station in the direction of rotation of the central roller, and laminated with the first frame material on the central roller, and the second frame material is transferred to the central roller at a third station, downstream of the second station in the direction of rotation of the central roller, and laminated with the composite of the membrane blanks and the first frame material on the central roller.

According to a second aspect, an apparatus for producing a membrane assembly in a web-processing process, in particular a membrane electrode assembly (MEA), is provided, the apparatus comprising a central roller, wherein three stations are provided on the circumference of the central roller, wherein the first station is designed to transfer a first frame material, which is fed as material from a roll, to the central roller, wherein the second station is disposed downstream of the first station in the direction of rotation of the central roller and is designed to transfer membrane blanks to the central roller and to laminate them with the first frame material on the central roller and wherein the third station is disposed downstream of the second station in the direction of rotation of the central roller and the third station is designed to transfer a second frame material, which is fed as material from a roll, to the central roller and to laminate it with the composite of the membrane blanks and the first frame material on the central roller.

In conjunction with the application, the terms “first” and “second” serve merely for differentiation and do not specify a sequence. The term “first” also does not necessarily require the presence of second, structurally identical or similar elements. In conjunction with the application, the term “a” is used as indefinite article and not as a numerical word.

The central roller enables accurate positioning of the frame material, which is provided as material from a roll, and a laminate, formed thereon, in a web-processing process plant for producing a membrane assembly. The frame material provided as material from a roll and a laminate formed thereon and—if present—a protective film and/or carrier sheet guided between the first frame material and the central roller are also referred to as wrap-around web below.

In an embodiment, the wrap-around angle, radius of the central roller and tension in the wrap-around web are selected such that the wrap-around web rests on the central roller and securely stays there, and an additional fixing force, for example by means of a vacuum or negative pressure in the interior of the roller, can be dispensed with. In another embodiment, the central roller is in the form of a vacuum roller. Dispensing with a vacuum and/or a negative pressure is advantageous in particular in the case of sensitive material webs and/or laminates, which can be deformed or damaged by suction openings on the circumference of the central cylinder.

The central roller is driven in rotation by means of a suitable drive.

The radius of the central roller is selected such that, owing to a curvature of the material webs along the circumference of the central roller, neither damage to the frame materials and/or the membrane blanks nor deformation occurs.

In conjunction with the application, the term “frame material” refers to a material which is applied to an outer side of a membrane blank. In an embodiment, it can be a resistant material for an edge reinforcement. However, the invention is not restricted to these materials. In an embodiment, the first and the second frame material are the same. In other embodiments, they are different.

In embodiments, punched outlines for windows are formed in the first and/or the second frame material, wherein the membrane blanks are deposited on the first frame material in the region of the windows and the second frame material is laminated onto the composite of the membrane blanks and the first frame material such that the windows coincide with the windows of the first frame material and border the membrane blanks. The punched outlines in each case are formed in the first frame material and the second frame material prior to transferring the first frame material and the second frame material to the central roller. In this case, the central roller only is used for transporting and stabilizing the cut material and is not used as an anvil roller for the cutting process. Removing the cutting process from the central roller allows for a higher flexibility for producing MEAs having different formats.

In an embodiment, at least one of the first frame material and the second frame material is provided on a protective film, wherein the protective film is delaminated in each case before transferring the first frame material and the second frame material to the central roller. Providing the frame material with a protective film allow to provide an adhesive coating on the frame material in advance. Thus, the adhesive coating can be applied particularly evenly to the frame material. In embodiments, the coating is activated after lamination with the membrane blanks.

In an embodiment, punched outlines for windows are formed in at least one of the first frame material provided on the protective film or the second frame material provided on the protective film prior to a delamination of the protective film. In embodiments, the punched outlines are cut or punched immediately before a delamination of the protective film. In embodiments, the punched outlines for windows are formed without cutting through the protective film. This prevents a weakening of the protective film and the frame material can be safely transported without distortion up to delamination.

In an embodiment, it is provided that at least one of the first frame material and the second frame material are transferred to the central roller by means of a transfer roller which is disposed on the circumference of the central roller and rotates synchronously with the central roller. In an embodiment, the membrane blanks are applied directly by means of a dispensing apparatus to the frame material transported by means of the central roller, without a transfer roller being provided for this.

In one configuration, at least one of the first station and the second station has a transfer roller, which is disposed on the circumference of the central roller and forms a gap with the central roller or makes contact with the central roller. In this respect, depending on the use case a gap dimension can be selected suitably by those skilled in the art, for example to obtain a secure lamination at the second station. In an embodiment, it is provided that a gap dimension can be set. As an alternative, in another embodiment it is provided that one or more transfer rollers are forced against the central roller by means of a force element. When there is no web provided between the central roller and the transfer roller, in an embodiment the transfer roller makes contact with the central roller.

In an embodiment, it is provided that at least one of the first frame material and the second frame material is provided on a protective film, wherein the protective film is delaminated from the frame material on the transfer roller. In this respect, in an embodiment, the punched outlines are formed directly before delamination of the protective film.

To this end, in an embodiment at least one of the first station and the third station has a delamination device, which is disposed on the circumference of the transfer roller and is designed to delaminate a protective film from the first frame material and the second frame material. In an embodiment, the delamination device comprises a delamination roller, a delamination edge and/or another delamination contour. In other embodiments, the delamination device comprises blowing nozzles or similar auxiliaries for detaching the protective film from the frame material for delamination. In yet other embodiments, the delamination device is designed to delaminate the protective film from the frame material without mechanical deflection aids and/or blowing nozzles.

The frame material, which is weakened due to the punching outlines, is stabilized by the protective film until it is taken over by the transfer roller and stabilized by means of the transfer roller, wherein in particular the protective film is not cut through or severed by punching outlines.

In an embodiment, the membrane blanks are transferred to the central roller by means of a transfer roller which is disposed on the circumference of the central roller and rotates synchronously with the central roller.

In an embodiment, the second station has a transfer roller, which is disposed on the circumference of the central roller and forms a gap with the central roller or makes contact with the central roller.

In an embodiment, the membrane blanks are provided on a protective film, wherein the protective film is delaminated from the membrane blanks on a delamination roller disposed upstream of the transfer roller and the membrane blanks are transferred from the delamination roller to the transfer roller. The combination of transfer roller and delamination roller makes it possible to change, in particular enlarge, a spacing between the membrane blanks after delamination, with the result that waste material which accumulates owing to the cutting to size operation can be kept low.

In an embodiment, the second station has a delamination roller disposed upstream of the transfer roller and a delamination device disposed on the circumference of the delamination roller, wherein the delamination device is designed to delaminate a protective film from the membrane blanks. The delamination device may in this respect be designed with an identical structure to or differently from the delamination devices disposed at the first and the third station.

For further processing of the membrane assembly in subsequent processes and/or for temporary storage prior to further processing, it can be advantageous when the membrane assembly is disposed on a carrier sheet.

In embodiments of the method, it is therefore provided that a first carrier sheet is transferred to the central roller upstream of the first frame material, wherein the membrane assembly is formed on the first carrier sheet, and/or a second carrier sheet is transferred to the central roller downstream of the second frame material, wherein the second carrier sheet is laminated onto the membrane assembly.

Similarly, in embodiments of the apparatus, a feed device for a first carrier sheet is provided upstream of the first station and is designed to transfer the first carrier sheet upstream of or with the first frame material to the central roller, with the result that the membrane assembly can be formed on the first carrier sheet, and/or a fourth station is provided downstream of the third station on the circumference of the central roller and is designed to transfer a second carrier sheet to the central roller, wherein the second carrier sheet can be laminated onto the membrane assembly.

### BRIEF DESCRIPTION OF THE DRAWINGS

Further advantages and aspects of the invention will become apparent from the claims and from the description of exemplary embodiments of the invention, which are explained below with reference to the schematic figures. In the figures:

FIG. 1 shows a first embodiment of an apparatus for producing the membrane assembly in a web-processing process on a central roller, in the case of which firstly a carrier sheet is guided onto the central roller and the membrane assembly is formed on the carrier sheet, and

FIG. 2 shows a second embodiment of an apparatus for producing the membrane assembly in a web-processing process on a central roller, in the case of which a carrier sheet is fed at the end of this process after the membrane has been formed on the central roller.

### DETAILED DESCRIPTION OF THE EXEMPLARY EMBODIMENTS

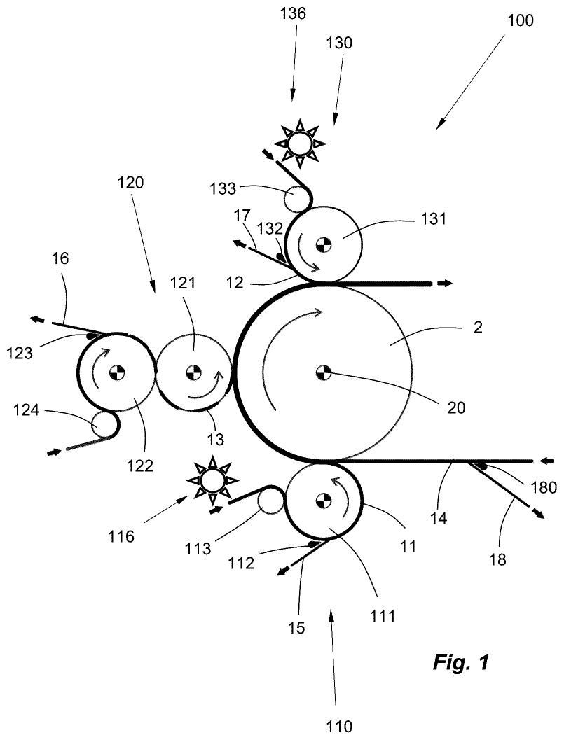

FIG. 1 schematically shows a first exemplary embodiment of an apparatus 100 for producing a membrane assembly in a web-processing process on a central roller 2 rotating about an axis 20.

The membrane assembly formed by means of the apparatus 100 comprises a first web-like frame material 11, a second web-like frame material 12 and membrane blanks 13 disposed between the first and the second frame material 11, 12. The membrane assembly also comprises a carrier sheet 14 provided as material from a roll.

The apparatus 100 comprises a first station 110, a second station 120 and a third station 130.

The first frame material 11 is transferred to the central roller 2 at the first station 110. The frame material 11 is provided as material from a roll and, in the exemplary embodiment illustrated, on a protective film 15. In the exemplary embodiment illustrated, the first frame material 11 is transferred to the central roller 2 by means of a transfer roller 111 rotating synchronously with the central roller 2, wherein, in the exemplary embodiment illustrated, the protective film 15 is drawn off from the first frame material 11 on the transfer roller 111 by means of a delamination device 112, which is illustrated schematically as a release edge. For secure wrapping around the transfer roller 111, a pressing roller 113 is provided.

Upstream of the transfer roller 111, a cutting device 116 is provided at the station 110, which cutting device 116 is designed to cut or form punching outlines for windows into the first frame material 11. The cutting device 116 is designed in such a way that the punching outlines are formed without cutting through the protective film 15. The protective film 15 ensures stabilization of the first frame material 11 during transport of the first frame material 11 to the transfer roller 111. After delamination of the protective film 15, stabilization of the frame material 11 is ensured by the transfer roller 111 and later the center roller 2.

The membrane blanks 13 are transferred to the central roller 2 at the second station 120 and are laminated onto the already present first frame material 11 there. The membrane blanks 13 are provided on a protective film 16. The second station 120 illustrated comprises a transfer roller 121 and a delamination roller 122 disposed upstream of the transfer roller 121. The transfer roller 121 rotates synchronously with the central roller 2. The delamination roller 122 and the transfer roller 121 are disposed and operated in such a way that a spacing between successive membrane blanks 13 can be enlarged upon transfer to the transfer roller 121. In the exemplary embodiment illustrated, the protective film 16 is drawn off from the membrane blanks 13 on the delamination roller 122 by means of a delamination device 123, which is illustrated schematically as a release edge. For secure wrapping around the delamination roller 122, a pressing roller 124 is provided.

The second frame material 12 is transferred to the central roller 2 at the third station 130 and laminated with the composite comprising the first frame material 11 and the membrane blanks 13, the composite being transported by the central roller 2. The third station 130 has a structurally identical design to the first station 110. The second frame material 12 is provided as material from a roll. In the exemplary embodiment illustrated, the second frame material 12 is transferred to the central roller 2 by means of a transfer roller 131 rotating synchronously with the central roller 2. In the exemplary embodiment illustrated, the second frame material 12 is provided on a protective film 17, wherein the protective film 17 is drawn off from the second frame material 12 on the transfer roller 131 by means of a delamination device 132, which is illustrated schematically as a release edge. For secure wrapping around the transfer roller 131, a pressing roller 133 is provided.

Upstream of the transfer roller 131, a cutting device 136 is provided at the third station 130, which cutting device 136 is designed to cut or form punching outlines for windows into the second frame material 12. The cutting device 136 in embodiments is designed in such a way that the punching outlines are formed without cutting through the protective film 17. The protective film 17 ensures stabilization of the second frame material 12 during transport of the second frame material 12 to the transfer roller 131. After delamination of the protective film 17, stabilization of the second frame material 12 is ensured by the transfer roller 131 and later the center roller 2.

To stabilize the laminate comprising the first frame material 11, the second frame material 12 and the interposed membrane blanks 13, in the exemplary embodiment illustrated the self-adhesive carrier sheet 14 is provided. The carrier sheet 14 is transferred to the central roller 2 upstream of or with the first frame material 11.

In the exemplary embodiment illustrated, the carrier sheet 14 is provided on a protective film 18, wherein the protective film 18 is drawn off from the carrier sheet 14 before the carrier sheet 14 is transferred to the central roller 2 by means of a delamination device 180, which is illustrated schematically as a release edge.

The central roller 2 is driven in rotation by means of a suitable drive. In the exemplary embodiment illustrated, drives are moreover also provided at the transfer rollers 111, 121, 131 and the delamination roller 122. In an embodiment, the drives at the transfer rollers 111, 121, 131 and the delamination roller 122 are designed such that these drives are used to compensate only frictional losses. In other embodiments, at least in part no drives are provided at the transfer rollers 111, 121, 131 and the delamination roller 122.

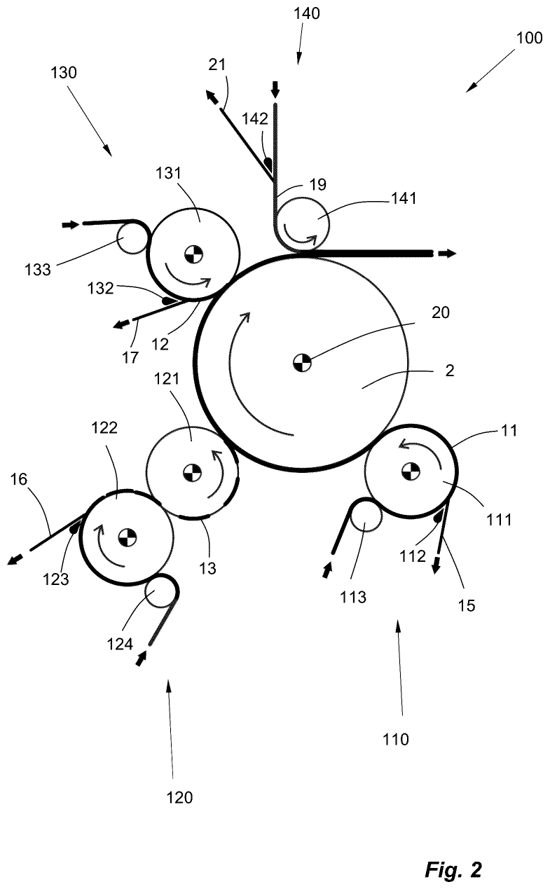

FIG. 2 schematically shows a second exemplary embodiment of an apparatus 100 for producing a membrane assembly on a central roller 2 rotating about an axis 20.

The apparatus 100 according to FIG. 2 is similar to the apparatus 100 according to FIG. 1 and consistent reference signs are used for components that are the same or similar. The apparatus 100 according to FIG. 2 comprises three stations 110, 120, 130, which at least substantially have the same function as the first station 110, the second station 120 and the third station 130 according to FIG. 1. Reference is made to the above text for a description of the stations 110, 120, 130.

By contrast to the design according to FIG. 1, in the case of the design according to FIG. 2 no first carrier sheet 14 which is transferred to the central roller 2 with the first frame material 11 is provided.

Instead, in the case of the design according to FIG. 2, a fourth station 140 is provided downstream of the third station 130 in the direction of rotation of the central roller 2, wherein at the fourth station 140 a second carrier sheet 19 is transferred to the central roller 2 and laminated onto a membrane assembly comprising the first frame material 11, the second frame material 12 and the interposed membrane blanks 13. In the exemplary embodiment illustrated, the second self-adhesive carrier sheet 19 is transferred to the central roller 2 by means of a roller 141.

The second carrier sheet 19 is provided on a protective film 21, wherein the protective film 212 is drawn off from the carrier sheet 19 before the carrier sheet 19 is transferred to the central roller 2 by means of a delamination device 142, which is illustrated schematically as a release edge.

The embodiments illustrated are merely by way of example and numerous modifications, for example formation without carrier sheets, in the case of which a membrane assembly is formed on a rotating central roller 2 are conceivable. In particular, instead of the arrangement illustrated of the first station below the central roller 2, it is conceivable to dispose the first station 110 above the central roller and the third station 130 below the central roller 2.

1. A method for producing a membrane assembly in a web-processing process, in particular a membrane electrode assembly (MEA), comprising:
providing a first frame material and a second frame material as material from a roll, and
forming the membrane assembly in a web-processing process, wherein membrane blanks are laminated with the first frame material and the second frame material is laminated with the composite comprising the first frame material and the membrane blanks,
wherein the membrane assembly is formed on a rotating central roller,
wherein the first frame material is transferred to the central roller at a first station,
wherein the membrane blanks are transferred to the central roller at a second station, downstream of the first station in the direction of rotation of the central roller, and laminated with the first frame material on the central roller, and
the second frame material is transferred to the central roller at a third station, downstream of the second station in the direction of rotation of the central roller, and laminated with the composite of the membrane blanks and the first frame material (on the central roller.

2. The method according to claim 1, wherein at least one of the first frame material and the second frame material is provided on a protective film, wherein the protective film is delaminated in each case before transferring the first frame material and the second frame material to the central roller.

3. The method according to claim 2, wherein punched outlines for windows are formed in at least one of the first frame material provided on the protective film or the second frame material provided on the protective film prior to a delamination of the protective film, wherein in particular the punched outlines for windows are formed without cutting through the protective film.

4. The method according to claim 1, wherein at least one of the first frame material and the second frame material is transferred to the central roller by means of a transfer roller which in each case is disposed on the circumference of the central roller and rotates synchronously with the central roller.

5. The method according to claim 4, wherein at least one of the first frame material and the second frame material is provided on a protective film, wherein on the respective transfer roller the protective film is delaminated from the first frame material and the second frame material.

6. The method according to claim 1, wherein the membrane blanks are transferred to the central roller by means of a transfer roller which is disposed on the circumference of the central roller and rotates synchronously with the central roller.

7. The method according to claim 6, wherein the membrane blanks are provided on a protective film, wherein the protective film is delaminated from the membrane blanks on a delamination roller disposed upstream of the transfer roller and the membrane blanks are transferred from the delamination roller to the transfer roller.

8. The method according to claim 1, wherein a first carrier sheet is transferred to the central roller upstream of the first frame material, wherein the membrane assembly is formed on the first carrier sheet.

9. The method according to claim 1, wherein a second carrier sheet is transferred to the central roller downstream of the second frame material, wherein the second carrier sheet is laminated onto the membrane assembly.

10. An apparatus for producing a membrane assembly in a web-processing process, in particular a membrane electrode assembly (MEA), comprising a central roller,
wherein three stations are provided on the circumference of the central roller,
wherein the first station is designed to transfer a first frame material, which is fed as material from a roll, to the central roller,
wherein the second station is disposed downstream of the first station in the direction of rotation of the central roller and is designed to transfer membrane blanks to the central roller and to laminate them with the first frame material on the central roller and
wherein the third station is disposed downstream of the second station in the direction of rotation of the central roller and the third station is designed to transfer a second frame material, which is fed as material from a roll, to the central roller and to laminate it with the composite of the membrane blanks and the first frame material on the central roller.

11. The apparatus according to claim 10, wherein at least one of the first station and the third station has a delamination device, which is designed to delaminate a protective film from the first frame material and the second frame material, respectively.

12. The apparatus according to claim 11, wherein upstream of at least one of a first delamination device at the first station and a second delamination device at the third station a cutting device is provided, which is designed for forming punched outlines for windows in the first frame material provided on the protective film or the second frame material provided on the protective film prior to a delamination of the protective film.

13. The apparatus according to claim 10, wherein at least one of the first station and the third station has a transfer roller, which is disposed on the circumference of the central roller and forms a gap with the central roller or makes contact with the central roller.

14. The apparatus according to claim 13, wherein at least one of the first station and the third station has a delamination device, which is designed to delaminate a protective film from the first frame material and the second frame material, respectively.

15. The apparatus according to claim 10, wherein the second station has a transfer roller, which is disposed on the circumference of the central roller and forms a gap with the central roller or makes contact with the central roller.

16. The apparatus according to claim 15, wherein the second station has a delamination roller disposed upstream of the transfer roller and a delamination device disposed on the circumference of the delamination roller, wherein the delamination device is designed to delaminate a protective film from the membrane blanks.

17. The apparatus according to claim 10, wherein a feed device for a first carrier sheet is provided upstream of the first station and is designed to transfer the first carrier sheet upstream of or with the first frame material to the central roller, with the result that the membrane assembly can be formed on the first carrier sheet-

18. The apparatus according to claim 10, wherein a fourth station is provided downstream of the third station on the circumference of the central roller and is designed to transfer a second carrier sheet to the central roller, wherein the second carrier sheet can be laminated onto the membrane assembly.
